(19) United States
(12) Patent Application Publication
(10) Pub. No.: US 2020/0401769 A1
(43) Pub. Date: Dec. 24, 2020

(54) DATA CONVERSION SYSTEM, DATA CONVERSION METHOD, AND PROGRAM

(71) Applicant: Panasonic Intellectual Property Management Co., Ltd., Osaka (JP)

(72) Inventor: Takao SAITO, Nara (JP)

(73) Assignee: Panasonic Intellectual Property Management Co., Ltd., Osaka (JP)

(21) Appl. No.: 16/975,266

(22) PCT Filed: Feb. 22, 2019
(86) PCT No.: PCT/JP2019/006889

§ 371 Date: Aug. 24, 2020

(30) Foreign Application Priority Data
Feb. 27, 2018 (JP) 2018-033934

(51) Int. Cl. G06F 40/56; G06F 40/58; G06F 16/35; G06F 16/33

(52) U.S. Cl. CPC G06F 40/56; G06F 16/3344; G06F 16/35; G06F 40/58

(57) ABSTRACT

A data conversion system includes an acquisition unit, a conversion unit, and an output unit. The acquisition unit acquires first data. The conversion unit converts the first data into second data based on a conversion parameter to be determined by reference data related to a subject. The output unit outputs the second data.

### TECHNICAL FIELD

The present disclosure generally relates to a data conversion system, a data conversion method, and a program. More particularly, the present disclosure relates to a data conversion system, a data conversion method, and a program, all of which are configured or designed to convert first data into second data.

### BACKGROUND ART

Patent Literature 1 discloses a translation device for converting a sentence in a first language expressed in the form of either a speech or a character string into a sentence in a second language as a target language. The translation device of Patent Literature 1 presents, for a single sentence entered in the first language, a plurality of options in the second language bearing the same meaning as the sentence in the first language but providing different levels of emotional expressions such that these options are displayed in the order of those levels of emotions. Then, the translation device accepts the user's first pick out of the plurality of options presented.

### CITATION LIST

### Patent Literature

Patent Literature 1: JP 2006-59017 A

### SUMMARY OF INVENTION

According to the configuration of Patent Literature 1, a plurality of options with mutually different emotional expressions are just presented in the order of their emotional levels. That is to say, the translation device of Patent Literature 1 does not convert (i.e., translate) the given sentence according to the subject's (i.e., user's) attributes. Therefore, according to the configuration of Patent Literature 1, a gap between the subject's usual style and the style of the second data converted (i.e., the sentence in the second language), for example, could give a sense of unnaturalness or uncomfortableness to the listener.

It is therefore an object of the present disclosure to provide a data conversion system, data conversion method, and a program, all of which reduce the chances of the data conversion giving such a sense of unnaturalness or uncomfortableness to the user.

A data conversion system according to an aspect of the present disclosure includes an acquisition unit, a conversion unit, and an output unit. The acquisition unit acquires first data. The conversion unit converts the first data into second data based on a conversion parameter to be determined by reference data related to a subject. The output unit outputs the second data.

A data conversion method according to another aspect of the present disclosure includes: acquiring first data; and converting the first data into second data based on a conversion parameter to be determined by reference data related to a subject and outputting the second data.

A program according to still another aspect of the present disclosure is designed to cause a computer system to perform the data conversion method described above.

### BRIEF DESCRIPTION OF DRAWINGS

FIG. 1 is block diagram illustrating a configuration for a data conversion system according to a first embodiment;

FIG. 2 is a conceptual diagram illustrating how the data conversion system works;

FIG. 3 is a flowchart showing an exemplary operation of the data conversion system;

FIG. 4A illustrates an exemplary screen to be displayed on the data conversion system being operated;

FIG. 4B illustrates an exemplary screen to be displayed on the data conversion system that has been operated;

FIG. 5A illustrates an exemplary screen to be displayed on the data conversion system being operated;

FIG. 5B illustrates an exemplary screen to be displayed on the data conversion system that has been operated; and

FIG. 6 illustrates an exemplary two-dimensional model, called “Russell's circumplex model,” representing human emotions for use in the data conversion system to make determination about emotions.

### DESCRIPTION OF EMBODIMENTS

### First Embodiment

(1) Overview

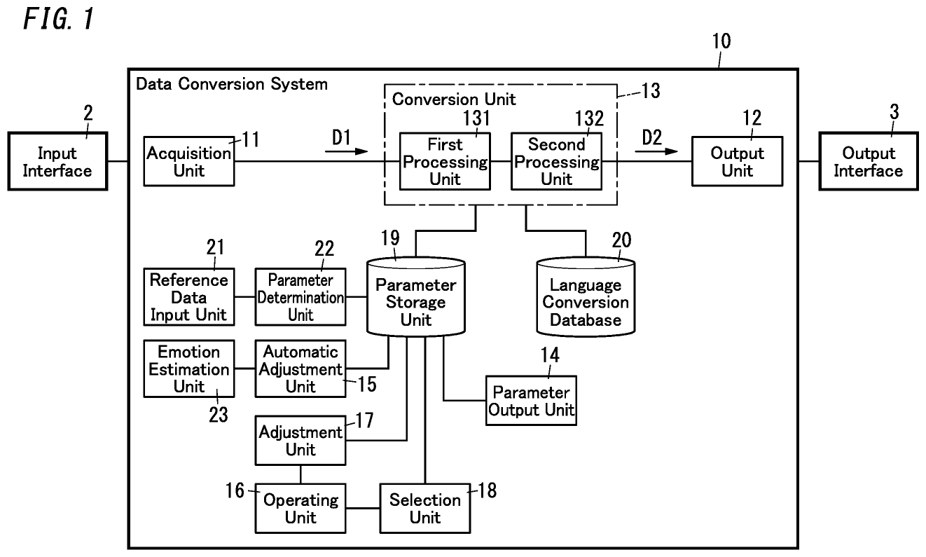

A data conversion system 10 according to a first exemplary embodiment includes an acquisition unit 11 for acquiring first data D1 and an output unit 12 for outputting second data D2 as shown in FIG. 1. The data conversion system 10 further includes a conversion unit 13 for converting the first data D1 into the second data D2.

That is to say, this data conversion system 10 has the first data D1, acquired by the acquisition unit 11, converted by the conversion unit 13 into the second data D2 and then has the second data D2 generated by conversion output by the output unit 12. As used herein, the “conversion” means generating the second data D2 from the first data D1 by changing the mode of expression while maintaining the identity of the essential contents (such as the concept and meaning) of the first data D1. Examples of the “conversion” includes various types of arrangements such as translation, adaptation, transcription, and fictionalization. Specifically, if the first data D1 and the second data D2 are both language data, for example, then the “conversion” involves translation and other forms of arrangements. Meanwhile, if the first data D1 and the second data D2 are both music data, then the “conversion” involves “transcription” and other forms of arrangements.

In this case, in the data conversion system 10 according to this embodiment, when converting the first data D1 into the second data D2, the conversion unit 13 performs the conversion based on a conversion parameter. The “conversion parameter” is a parameter to be determined by reference data related to the subject. As used herein, the “subject” refers to the person who has created the first data D1, i.e., the creator of the first data D1. In short, the first data D1 is not measurement data collected by the sensor or mere text data with no meanings at all, for example, but data about some type of work created by a human being such as sentences, musical tunes, paintings, and dances (choreography).

Also, as used herein, the “creator” refers to a person who substantively created the first data D1, not a person who has nothing to do with the creation of the first data D1, such as the agent, administrator, assistant, or supporter of the creator of the first data D1. Specifically, if the first data D1 is a sentence, then the creator of the first data D1 is the person who composed the sentence. Meanwhile, a person who just entered the first data D1 by operating a keyboard or any other input device in place of the creator, or a person who just performed, on a computer system, the operation of reading the first data D1 from a non-transitory storage medium is not the creator of the first data D1.

That is to say, according to this embodiment, the conversion unit 13 converts the first data D1 into the second data D2 based on the “conversion parameter” to be determined by reference data related to the subject who is the creator of the first data D1. This allows the second data D2 generated by conversion to reflect an expression peculiar to the subject who is the creator of the first data D1. For example, if the first data D1 is a sentence, the second data D2 generated by conversion is allowed to reflect the style peculiar to the subject who is the creator of the first data D1, thus narrowing the gap between the subject's usual style and the style of the second data D2 generated by conversion. Consequently, the data conversion system 10 according to this embodiment achieves the advantage of reducing the chances of the data conversion giving a sense of unnaturalness or uncomfortableness to the user.

(2) Details

Next, the data conversion system 10 according to this embodiment will be described in further detail. In the following description of embodiments, at least one of the first data D1 to be converted or the second data D2 generated by conversion is supposed to be data about a “language,” i.e., language data. In the following example, both of the first data D1 and the second data D2 are supposed to be language data.

As used herein, the “language” refers to a symbol system to be used by a human to communicate things (such as thoughts, emotions, and intentions) either by speech or in characters. Furthermore, the “classification of language” herein refers to the attributes of a language used by a particular group as a means for communicating things by speech or in characters, and may refer to the attributes of two or more different languages that make it difficult for people who use them to have them understood by each other, as in the case of individual languages. For example, the “classifications of languages” correspond to Japanese, English, Chinese, German, and other “official languages” used in various countries and “dialects” used in only particular districts.

(2.1) Configuration

First, the configuration of the data conversion system 10 according to this embodiment will be described in detail with reference to FIG. 1.

The data conversion system 10 includes the acquisition unit 11, the output unit 12, and the conversion unit 13 as described above. The data conversion system 10 further includes a parameter output unit 14, an automatic adjustment unit 15, an operating unit 16, an adjustment unit 17, a selection unit 18, a parameter storage unit 19, a language conversion database 20, a reference data input unit 21, a parameter determination unit 22, and an emotion estimation unit 23. Nevertheless, at least some of the parameter output unit 14, the automatic adjustment unit 15, the operating unit 16, the adjustment unit 17, the selection unit 18, the parameter storage unit 19, the language conversion database 20, the reference data input unit 21, the parameter determination unit 22, and the emotion estimation unit 23 may be omitted as appropriate.

The data conversion system 10 includes, as its major constituent element, a computer system including a processor and a memory. The computer system performs the function of the data conversion system 10 by making the processor execute a program stored in the memory. As used herein, the “computer system” refers to a server device on the Internet or a cloud computing system as well.

In this embodiment, the data conversion system 10 is connected to an input interface 2 and an output interface 3. The first data D1 to be converted by the data conversion system 10 is input from the input interface 2 to the data conversion system 10. The second data D2 generated by conversion by the data conversion system 10 is output from the data conversion system 10 to the output interface 3. That is to say, the first data D1 that has been input from the input interface 2 to the data conversion system 10 is converted by the data conversion system 10 and then output as second data D2 from the data conversion system 10 to the output interface 3.

Each of the input interface 2 and the output interface 3 may be connected to the data conversion system 10 via wireless communication or wired communication, for example. Each of the input interface 2 and the output interface 3 may be implemented as a telecommunications device such as a smartphone, a tablet computer, or a wearable device. Optionally, a single telecommunications device may have the functions of both the input interface 2 and the output interface 3.

The acquisition unit 11 acquires the first data D1. In this embodiment, the acquisition unit 11 acquires the first data D1 from the input interface 2 by communicating with the input interface 2. The input interface 2 receives the first data D1 that has been created by the subject (who is the creator of the first data D1) by entering either characters or a speech, for example. As used herein, “entering characters” refers to the subject's entering data of a character string (text data) directly by operating an input device such as a touchscreen panel display, a keyboard, or a pointing device. As used herein, “entering a speech” refers to extracting data of a character string (text data) from a speech uttered by the subject by converting the speech into an electrical signal using a microphone and performing speech recognition on the electrical signal (audio signal). Optionally, the input interface 2 may perform at least a part of natural language processing such as semantic analysis and syntactic analysis.

Nevertheless, the acquisition unit 11 does not have to acquire the first data D1 as in the example described above. Alternatively, the acquisition unit 11 may acquire the first data D1 stored in a non-transitory storage medium readable for a computer system from the non-transitory storage medium. Also, if the data conversion system 10 itself includes a user interface, the acquisition unit 11 may acquire the first data D1 input through the user interface of the data conversion system 10.

The output unit 12 outputs the second data D2. The second data D2 is data generated by having the first data D1 acquired by the acquisition unit 11 converted by the conversion unit 13. In this embodiment, the output unit 12 outputs the second data D2 to the output interface 3 by communicating with the output interface 3. The output interface 3 delivers (i.e., presents) the second data D2 that has been output by the output unit 12 by either displaying some type of visual information or emitting some type of audio information. As used herein, to “display some type of visual information” refers to presenting data on a display as characters, signs, numerals, images, or a combination thereof in such a form that allows a human being to understand the data. Also, as used herein, to “emit some type of audio information” refers to converting the electrical signal (audio signal) into a sound (or a voice/speech) through a loudspeaker and reproducing the sound (or a voice/speech) in such a form that allows a human being to understand the data.

Nevertheless, the output unit 12 does not have to output the second data D2 as in the example described above. Alternatively, the output unit 12 may output the second data D2 by writing the second data D2 onto a non-transitory storage medium readable for a computer system. Still alternatively, the output unit 12 may transmit the second data D2 to any device other than the output interface 3. For example, if the destination device is a printer, then the printer outputs the second data D2 as a printed matter. Optionally, if the data conversion system 10 itself includes a user interface, then the output unit 12 may output the second data D2 as either some type of visual information or some type of audio information through the user interface of the data conversion system 10.

The conversion unit 13 converts the first data D1 into the second data D2. That is to say, the first data D1 that has been acquired by the acquisition unit 11 is converted by the conversion unit 13 into the second data D2, and the second data D2 generated by conversion is output by the output unit 12. In this embodiment, the conversion unit 13 converts the first data D1 into the second data D2 based on a conversion parameter.

The conversion parameter is a parameter to be determined by reference data related to the subject (who is the creator of the first data D1). As used herein, the “reference data” refers to data related to the subject and is suitably data reflecting an expression peculiar to the subject (i.e., data reflecting the subject's own method of expressing the first data D1). For example, if both the first data D1 and the second data D2 are language data, then the “reference data” is suitably data characterizing the language data such as the subject's unique style, favorite phrases, and peculiar expressions. Furthermore, as used herein, the “style” refers to the style of a sentence reflecting the creator's individual characteristics. Examples of the reference data include text data of sentences created by the subject which are included in emails, postings on a social networking service (SNS), memos, and document files and text data extracted from the subject's conversations.

Alternatively, the reference data may also be data of a different type from the first data D1 and the second data D2 such as data of music (musical tune) created by the subject or data of a painting (image) created by the subject. Optionally, the reference data may further include data about the subject's attributes. As used herein, the “attributes” include his or her sex, age, occupation, family lineage origin, family makeup, career (including academic and professional careers), and social standing.

That is to say, in this embodiment, the conversion unit 13 converts the first data D1 as language data into the second data D2 as language data based on the conversion parameter. In this embodiment, the first data D1 and the second data D2 may be either language data of the same classification or language data of mutually different classifications. If the first data D1 and the second data D2 are language data of the same classification, then the conversion unit 13 mainly changes the expression without making “translation.” On the other hand, if the first data D1 and the second data D2 are language data of mutually different classifications, then the conversion unit 13 makes at least “translation.”

As will be described in detail in the “(2.2.1) Basic operation” section, according to this embodiment, the classification of the first data D1 and the classification of the second data D2 may be specified on an individual basis. Thus, if the classification of the first data D1 is specified as “Japanese” and the classification of the second data D2 is specified as “Japanese,” then the first data D1 and the second data D2 are language data of the same classification. On the other hand, if the classification of the first data D1 is specified as “English” and the classification of the second data D2 is specified as “Japanese,” then the first data D1 and the second data D2 are language data of two different classifications.

In this embodiment, the conversion unit 13 performs at least two stages of processing including first conversion processing and second conversion processing. The first conversion processing is the processing of converting the first data D1 into standard data that has been standardized. The second conversion processing is processing of converting the standard data generated by the first conversion processing into the second data D2. That is to say, the conversion unit 13 does not convert the first data D1 into the second data D2 at a time but once converts the first data D1 into the standard data as intermediate data and then generates second data D2 from the standard data. As used herein, the “standard data” refers to data generated by standardizing the first data D1. Basically, the “standard data” is obtained by removing the expressions peculiar to the subject (who is the creator of the first data D1) and the expressions unique to the classification of language from the first data D1. Therefore, if multiple items of the first data D1 are sentences with the same meaning, then the same standard data will be generated from the multiple items of the first data D1 irrespective of the creator of the first data D1 and the classification of the first data D1.

More specifically, the conversion unit 13 includes a first processing unit 131 for performing the first conversion processing and a second processing unit 132 for performing the second conversion processing. The first processing unit 131 converts the first data D1 into the standard data by reference to the language conversion database 20 and outputs the standard data generated by conversion to the second processing unit 132. The second processing unit 132 converts the standard data into the second data D2 by reference to the parameter storage unit 19 and the language conversion database 20 and outputs the second data D2 generated by conversion to the output unit 12. In this case, the conversion parameter is reflected when the standard data is converted into the second data D2. That is to say, the second processing unit 132 converts the standard data into the second data D2 based on the conversion parameter. This allows the second data D2 to reflect an expression peculiar to the subject.

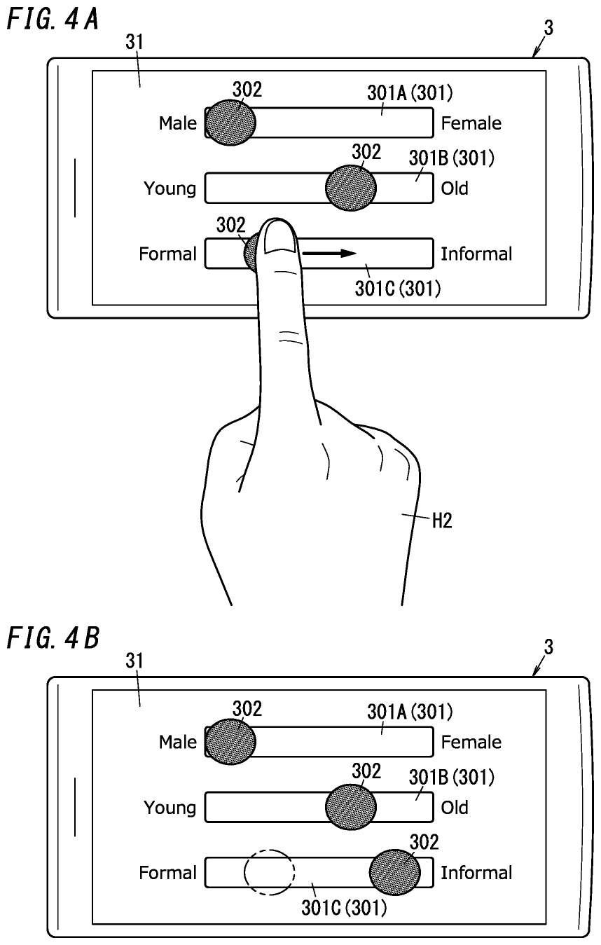

The parameter output unit 14 outputs the conversion parameter. In this embodiment, the parameter output unit 14 outputs the conversion parameter to the output interface 3 by communicating with the output interface 3. The output interface 3 delivers (presents) the conversion parameter output by the parameter output unit 14 as some type of visual information or some type of audio information, for example. As will be described in detail in the “(2.2.2) Manual adjustment processing” section, the conversion parameter output by the parameter output unit 14 may be presented in the form of parameter gauges 301 (see FIG. 4A) on the display unit 31 (see FIG. 4A). As used herein, the “parameter gauges” each refer to a graph representing the conversion parameter by the position of a cursor 302 (see FIG. 4A).

The automatic adjustment unit 15 automatically adjusts the conversion parameter. The automatic adjustment unit 15 may adjust the conversion parameter into an appropriate one according to time, place, and occasion (TPO), for example. The automatic adjustment unit 15 may adjust the value of the conversion parameter stored in the parameter storage unit 19, for example. However, this is only an example and should not be construed as limiting. Alternatively, the automatic adjustment unit 15 may also adjust the value of the conversion parameter that the conversion unit 13 uses, for example. As will be described in detail in the “(2.2.3) Automatic adjustment processing” section, the automatic adjustment unit 15 suitably adjusts the conversion parameter according to the receiver of the second data D2. If the second data D2 is a sentence, then the reader or listener of the second data D2 is the receiver of the second data D2.

The operating unit 16 receives an operating signal representing an operating command entered by a person. The operating unit 16 may be connected to any of various user interfaces including a touchscreen panel display, a keyboard, and a pointing device such as a mouse. Thus, when a person operates (i.e., enters an operating command through) the user interface, the operating unit 16 receives an electrical signal (operating signal) representing the operating command entered. The person who operates (the user interface) to give an operating signal to the operating unit 16 may be the receiver of the second data D2 or the creator of the first data D1, for example.

The adjustment unit 17 adjusts the conversion parameter in accordance with the operating signal. That is to say, when the operating unit 16 receives the operating signal representing the operating command entered by the person, the adjustment unit 17 adjusts the conversion parameter in accordance with the operating signal. In other words, the conversion parameter may be adjusted manually by the operating unit 16 and the adjustment unit 17. As will be described in detail in the “(2.2.2) Manual adjustment processing” section, the receiver of the second data D2 performing an operation to give the operating signal to the operating unit 16 makes the conversion parameter adjustable according to the second data D2 receiver's mood or preference, for example.

The selection unit 18 selects a conversion parameter for use by the conversion unit 13 for conversion from among a plurality of potential parameters. The plurality of potential parameters are associated one to one with a plurality of potential subjects, one of which is determined to be the subject. In this embodiment, the selection unit 18 selects the subject from among the plurality of potential subjects in accordance with the operating signal received by the operating unit 16. That is to say, in this embodiment, a plurality of potential subjects are set in advance and any one of the potential subjects is selected as the subject by the selection unit 18. This allows the conversion parameter associated with the plausible potential subject to be selected substantially on a one-to-one basis.

The parameter storage unit 19 stores the conversion parameter to be determined by the reference data related to the subject. The parameter storage unit 19 may be implemented as a non-transitory storage medium, which is readable for a computer system, for example. The conversion parameter is stored in the parameter storage unit 19 in association with the subject.

In this embodiment, a data set including plurality of conversion parameters is stored in the parameter storage unit 19. The conversion parameter stored in the parameter storage unit 19 is used at least in the second conversion processing of converting the standard data into the second data D2. Also, as will be described in detail in the “(2.2.1) Basic operation” section, the conversion parameter includes multiple items. As used herein, the “multiple items” refers to a plurality of constituent elements of the conversion parameter and each contributes to converting the first data D1 into the second data D2.

The language conversion database 20 stores language conversion data required to make the basic conversion from the first data D1 into the second data D2. As used herein, the “language conversion data” is data defining a basic conversion rule in terms of words and grammar, for example, which is required to change the classification of the language (i.e., to make translation). The language conversion database 20 may be implemented, for example, as a non-transitory storage medium readable for a computer system. The language conversion data is stored in the language conversion database 20 in association with the classification of the language. In this embodiment, a data set including multiple items of the language conversion data is stored in the language conversion database 20. The language conversion data stored in the language conversion database 20 is used in both the first conversion processing of converting the first data D1 into the standard data and the second conversion processing of converting the standard data into the second data D2.

The reference data input unit 21 acquires the reference data. The reference data input unit 21 acquires the reference data in association with identification information for use to identify the subject. This makes the reference data acquired by the reference data input unit 21 distinguishable from one subject to another (i.e., on the basis of the identification information). As described above, examples of the reference data include text data of sentences created by the subject which are included in emails, postings on a social networking service (SNS), memos, and document files and text data extracted from the subject's conversations. The reference data acquired by the reference data input unit 21 may be stored in, for example, a non-transitory storage medium readable for a computer system. The reference data input unit 21 collects the reference data over a predetermined accumulation period (e.g., over the past few months to the past few years).

The parameter determination unit 22 determines the conversion parameter based on the reference data that the reference data input unit 21 has acquired (or collected) over the accumulation period. That is to say, the parameter determination unit 22 generates the conversion parameter based on multiple items of the reference data. In this case, the parameter determination unit 22 stores the conversion parameter thus generated in the parameter storage unit 19 in association with the subject.

The emotion estimation unit 23 estimates the emotion information about at least one of the subject (who is the creator of the first data D1) or the receiver of the second data D2. As used herein, the “emotion information” is information expressing a person's emotions such as surprise, pleasure, boredom, and sadness. For example, the emotion information may be represented, for example, as a combination of an arousal level indicating the degree to which the person is awaken and the valence level indicating the degree of the person's comfortableness. The result of the estimation made by the emotion estimation unit 23 is output to the automatic adjustment unit 15 and used by the automatic adjustment unit 15 to adjust the conversion parameter. That is to say, the automatic adjustment unit adjusts the conversion parameter according to the emotion information expressing the person's emotions. For example, the emotion estimation unit 23 obtains the emotion information by subjecting the image, captured by a camera, of either the subject or the second data D2 receiver to face recognition processing, for example. The emotion determination algorithm for use in the emotion estimation unit 23 will be described in detail in the “(2.2.3) Automatic adjustment processing” section.

(2.2) Operation

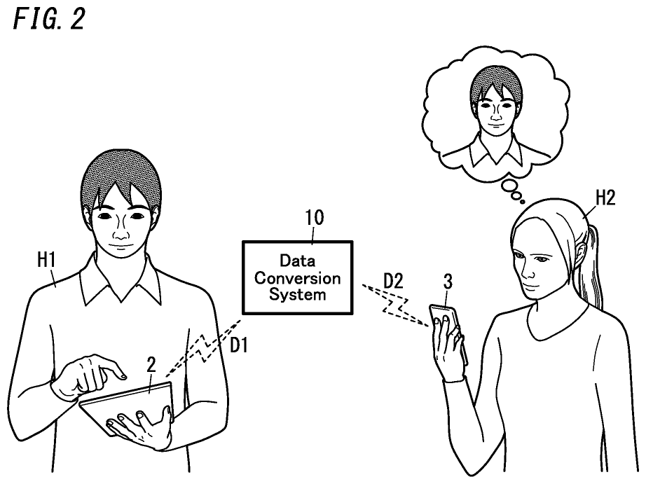

Next, it will be described with reference to FIGS. 2-6 how the data conversion system 10 according to this embodiment works.

(2.2.1) Basic Operation

As shown in FIG. 2, the data conversion system 10 according to this embodiment performs its basic operation by converting the first data D1 input from the input interface 2 into the second data D2 and outputting the second data D2 generated by conversion to the output interface 3. In the example illustrated in FIG. 2, the subject H1 is supposed to input first data D1 as Japanese language data using the input interface 2 and the receiver H2 of second data D2 is supposed to receive the second data D2 as English language data at the output interface 3. In this case, even though the subject H1 (who is the creator of the first data D1) and the receiver H2 of the second data D2 are present at remote locations, they are able to transmit the first data D1 and receive the second data D2 just like sending and receiving emails.

In the example illustrated in FIG. 2, the data conversion system 10 serves as a language data relay device between the input interface 2 and the output interface 3. In addition, in relaying the language data, the data conversion system 10 performs at least “translation” as the processing of converting the first data D1 as Japanese language data into the second data D2 as English language data.

Furthermore, in relaying the language data, the data conversion system 10 converts the first data D1 into the second data D2 based on the “conversion parameter” to be determined by the reference data related to the subject H1 who is the creator of the first data D1. This allows the second data D2 presented on the output interface 3 to reflect an expression peculiar to the subject H1 who is the creator of the first data D1. For example, the second data D2 is allowed to reflect the style of the subject H1 who is the creator of the first data D1, thus narrowing the gap between the subject's H1 usual style and the style of the second data D2 generated by conversion. This allows the second data D2 receiver H2 to sense the subject's H1 mood by the style of the second data D2 presented on the output interface 3. Consequently, the data conversion system 10 according to this embodiment achieves the advantage of reducing the chances of the data conversion giving a sense of unnaturalness or uncomfortableness to the user.

Note that the situation illustrated in FIG. 2 is only an example. Alternatively, the data conversion system 10 is also applicable to a situation where the subject H1 is going to send some type of message to the second data D2 receiver H2 who is present right in front of him or her, for example.

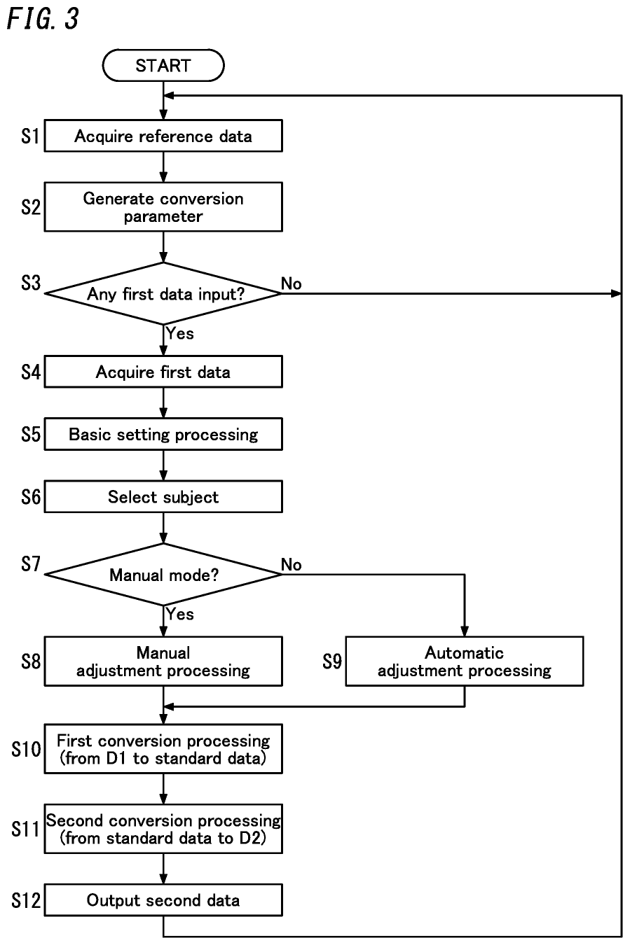

FIG. 3 is a flowchart showing an exemplary procedure of operation of the data conversion system 10.

Specifically, the data conversion system 10 makes the reference data input unit 21 acquire reference data as needed (in S1) and makes the parameter determination unit 22 generate the conversion parameter based on the reference data acquired and collected over the accumulation period (in S2). The conversion parameter generated by the parameter determination unit 22 is stored in the parameter storage unit 19 in association with the subject H1. Then, the data conversion system 10 sees if any first data D1 has been input (in S3). When finding that no first data D1 has been input (if the answer is NO in S3), the data conversion system 10 performs the series of processing steps S1-S3 repeatedly. This allows the conversion parameter stored in the parameter storage unit 19 to be updated as needed based on the reference data such as the text data of sentences created by the subject H1 on a daily basis which are included in emails, postings on the SNS, memos, and document files.

On the other hand, when finding that any first data D1 has been input (if the answer is YES in S3), the data conversion system 10 makes the acquisition unit 11 acquire the first data D1 from the input interface 2 (in S4). Thereafter, the data conversion system 10 starts performing basic setting processing (S5) about the conversion of the first data D1. The basic setting processing includes specifying an appropriate setting item in accordance with the operation performed on the input interface 2 or the output interface 3. The setting item includes at least the classification of the first data D1 and the classification of the second data D2. According to this embodiment, the classification of the first data D1 and the classification of the second data D2 may be specified on an individual basis as described above. In this example, the subject H1 is supposed to specify the classification of the first data D1 as “Japanese language” and the classification of the second data D2 as “English language” by operating the input interface 2. However, this is only an example and should not be construed as limiting. Alternatively, if the classification of the first data D1 is automatically estimable based on the result of analysis of the first data D1, for example, then the classification of the first data D1 may be determined automatically.

When finishing the basic setting process (S5), the data conversion system 10 makes the selection unit 18 select the subject from among a plurality of potential subjects (in S6). This substantively allows a conversion parameter associated with the plausible potential subject to be selected from among a plurality of conversion parameters stored in the parameter storage unit 19.

Next, the data conversion system 10 determines whether or not the operation mode is a manual mode (in S7). The operation mode of the data conversion system 10 may be determined by, for example, the operation performed on the input interface 2 or the output interface 3. When finding the operation mode to be the manual mode (if the answer is YES in S7), the data conversion system 10 performs the conversion parameter manual adjustment processing (in S8). When finding the operation mode to be the manual mode (if the answer is YES in S7), the data conversion system 10 performs the conversion parameter manual adjustment processing (in S8). The conversion parameter manual adjustment processing will be described in detail in the “(2.2.2) Manual adjustment processing” section. On the other hand, when finding the operation mode to be a non-manual mode (if the answer is NO in S7), the data conversion system 10 performs the conversion parameter automatic adjustment processing (in S9). The conversion parameter automatic adjustment processing will be described in detail in the “(2.2.3) Automatic adjustment processing” section.

Next, the data conversion system 10 makes the first processing unit 131 of the conversion unit 13 perform the first conversion processing of converting the first data D1 into the standard data by reference to the language conversion database 20 (in S10). In this processing step, the first processing unit 131 converts the first data D1 into the standard data using the language conversion data stored in the language conversion database 20.

Thereafter, the data conversion system 10 makes the second processing unit 132 of the conversion unit 13 perform the second conversion processing of converting the standard data into the second data D2 by reference to the parameter storage unit 19 and the language conversion database 20 (in S11). In this processing step, the second processing unit 132 converts the standard data into the second data D2 by using the conversion parameter selected in the processing step S6 from among the plurality of conversion parameters stored in the parameter storage unit 19 and the language conversion data stored in the language conversion database 20.

Subsequently, the data conversion system 10 makes the output unit 12 output the second data D2 to the output interface 3 (in S12). The data conversion system 10 performs this series of processing steps S1-S12 over and over again. Note that the flowchart shown in FIG. 3 is only an example, and the order and specifics of the processing steps may be changed as appropriate.

In this embodiment, the conversion parameter includes multiple items as described above. Examples of those items included in the conversion parameter include sex (which may be male or female), age (which may be “young”), the degree of familiarity (or formality), social standing, intelligence, vocabulary, and a sense of humor. The conversion unit 13 may convert the first data D1 into the second data D2 by either collective conversion method that uses all of these items collectively or sequential conversion method that uses one of these items after another sequentially. Strictly speaking, in the second conversion processing of converting the standard data into the second data D2, the conversion is performed by either the collective conversion method or the sequential conversion method.

Specifically, according to the collective conversion method, the conversion unit 13 converts the first data D1 into the second data D2 by using all of the multiple items of the conversion parameter collectively. In this case, the conversion unit 13 converts the first data D1 into the second data D2 at a time by using a conversion parameter obtained by combining the multiple items together. Multiple items may be combined together by obtaining a logical product between the multiple items. For example, as for the two items such as “male” and “twenties,” a logical product may be obtained as “male” AND “twenties.” When multiple items are combined together, weighting may be performed on an item-by-item basis. The collective conversion method reduces the chances of causing an error of generating no second data D2, i.e., bringing about no solution with respect to the second data D2.

On the other hand, according to the sequential conversion method, the conversion unit 13 converts the first data D1 into the second data D2 by sequentially using multiple items of the conversion parameter one after another. In this case, the conversion unit 13 converts the first data D1 into the second data D2 on a step-by-step basis by using the multiple items one by one. This allows options of the second data D2 to be narrowed down sequentially, thus finally determining the second data D2 to be a particular one of these options. For example, as for the two items such as “male” and “twenties,” options of the second data D2 are narrowed down to “male” expressions through the first stage of the processing, which are then further narrowed down to “twenties” expressions through the second stage of the processing. According to the sequential conversion method, the options of the second data D2 are narrowed down on a step-by-step basis, thus allowing the second data D2 generated by conversion to reflect an expression peculiar to the subject H1 relatively finely.

(2.2.2) Manual Adjustment Processing

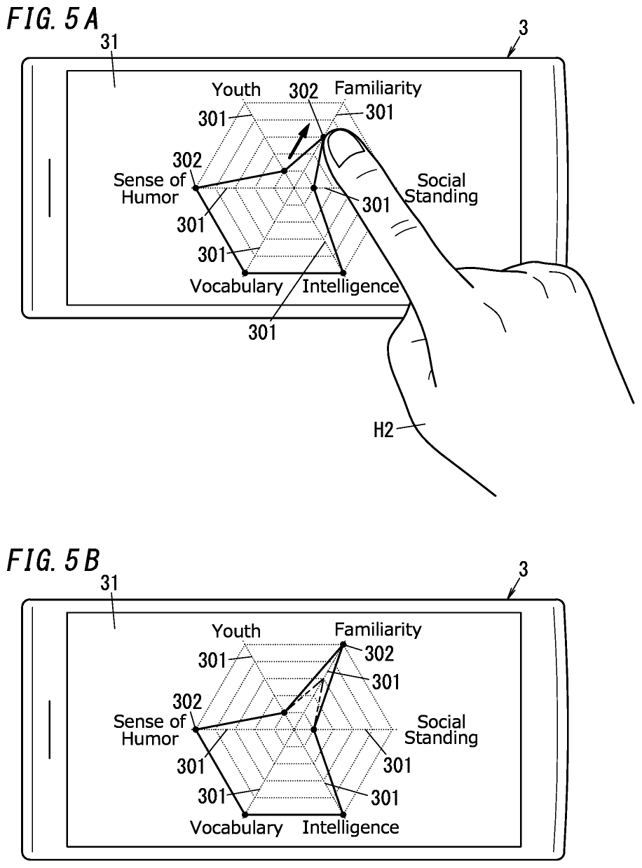

Next, the conversion parameter manual adjustment processing will be described with reference to FIGS. 4A-5B. The conversion parameter manual adjustment processing is performed in response to the subject's H1 operation on the input interface 2 or the second data D2 receiver's H2 operation on the output interface 3. When the conversion parameter includes multiple items as in this embodiment, the manual adjustment processing allows the conversion parameter to be adjusted on an item-by-item basis. In the example illustrated in FIGS. 4A-5B, the manual adjustment processing is performed in response to the second data D2 receiver's H2 operation on the output interface 3.

In this case, the conversion parameter output by the parameter output unit 14 may be displayed, for example, in the form of parameter gauges 301 on the display unit 31 of the output interface 3 as shown in FIG. 4A. The parameter gauges 301 are linear graphs extending horizontally (i.e., in the rightward/leftward direction) on the screen of the display unit 31. The values of the conversion parameter are indicated by the respective positions of cursors 302 displayed on these parameter gauges 301. The parameter gauges 301 are displayed for the respective items of the conversion parameter. In the example illustrated in FIG. 4A, displayed vertically (i.e., in the upward/downward direction) one on top of another in this order on the screen of the display unit 31 are a parameter gauge 301A indicating sex (which may be either “Male” or “Female”), a parameter gauge 301B indicating age (which may be “young,” for example), and a parameter gauge 301C indicating the degree of familiarity (or formality).

In this case, the display unit 31 is a touchscreen panel display and also serves as a user interface that accepts touch operations by the user of the output interface 3 (i.e., the second data D2 receiver H2). Thus, when a touch operation is performed on the display unit 31, the data conversion system 10 makes the operating unit 16 receive an electrical signal (operating signal) representing this operation. Furthermore, the data conversion system 10 makes the adjustment unit 17 adjust the conversion parameter in accordance with the operating signal received by the operating unit 16. Consequently, the touch operation on the display unit 31 makes the conversion parameter manually adjustable. For example, the second data D2 receiver's H2 adjusting the conversion parameter according to his or her mood or preference allows the conversion of the first data D1 into the second data D2 to be adapted to the second data D2 receiver H2.

More specifically, the operating unit 16 receives the operating signal, which is generated as a result of the operation of moving the position of the cursor 302 on each of the parameter gauges 301 representing the conversion parameter displayed on the display unit 31 by the positions of the cursors 302. Specifically, as illustrated in FIG. 4A, when the user of the output interface 3 (i.e., the second data D2 receiver H2) swipes the cursor 302 on the parameter gauge 301C with one of his or her fingers, an operating signal is generated as a result of this operation (i.e., swiping). In response, the adjustment unit 17 adjusts the conversion parameter in accordance with an operating signal generated as a result of such an operation. Specifically, in the example illustrated in FIG. 4A, the cursor 302 on the parameter gauge 301C indicating the degree of familiarity (or formality) is swiped from “Formal” toward “Informal.” This allows the item “degree of familiarity (or formality)” of the conversion parameter to be adjusted toward the “Informal” end. As a result, in the conversion parameter output by the parameter output unit 14, the cursor 302 on the parameter gauge 301C indicating the degree of familiarity (or formality) is also located closer to the “Informal” end. Note that in FIG. 4B, the position of the cursor 302 before swiping is indicated in phantom by the two-dot chain circle.

Making the conversion parameter adjustable through such an operation allows the user (i.e., the second data D2 receiver H2 in this case) to adjust the conversion parameter intuitively, thus facilitating the adjustment of the conversion parameter.

FIGS. 5A and 5B illustrate an example in which the conversion parameter output by the parameter output unit 14 is presented on the display unit 31 of the output interface 3 as parameter gauges 301 of a different type from the ones shown in FIGS. 4A and 4B. Specifically, in the example illustrated in FIG. 5A, the parameter gauges 301 are a graph consisting of multiple (e.g., six in this example) lines extending radially from the center of the screen of the display unit 31. Connecting the respective cursors 302 on these multiple parameter gauges 301 together forms a hexagonal radar chart. In the example illustrated in FIG. 5A, the parameter gauges 301 indicating the degree of familiarity, social standing, intelligence, vocabulary, sense of humor, and youth, respectively, are displayed clockwise in this order.

As in the example illustrated in FIG. 4A, when the user of the output interface 3 (i.e., the second data D2 receiver H2) swipes the cursor 302 on any of the parameter gauges 301 with one of his or her fingers, an operating signal is also generated in the example illustrated in FIG. 5A as a result of this operation (of swiping). Specifically, in the example illustrated in FIG. 5A, the cursor 302 on the parameter gauge 301 indicating the degree of familiarity is swiped away from the center of the radar chart. This allows the item “degree of familiarity” of the conversion parameter to be adjusted to a larger value. As a result, in the conversion parameter output by the parameter output unit 14, the cursor 302 on the parameter gauge 301 indicating the degree of familiarity is also displayed away from the center of the radar chart as shown in FIG. 5B, for example. Note that in FIG. 5B, the radar chart before swiping is indicated in phantom by two-dot chain lines.

(2.2.3) Automatic Adjustment Processing

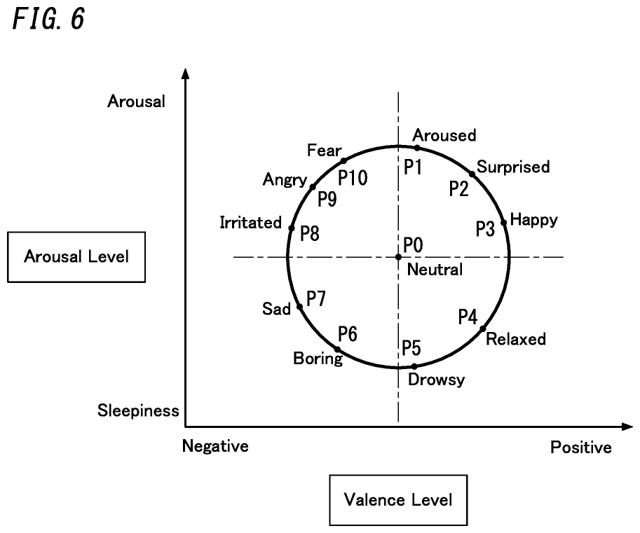

Next, the conversion parameter automatic adjustment processing will be described with reference to FIG. 6. The conversion parameter automatic adjustment processing is performed by the automatic adjustment unit 15 of the data conversion system 10 according to time, place, and occasion, for example. When the conversion parameter includes multiple items as in this embodiment, the automatic adjustment processing makes the conversion parameter adjustable on an item-by-item basis.

In this embodiment, the automatic adjustment unit 15 is supposed to adjust the conversion parameter adaptively at least to the second data D2 receiver H2 as an example. Specifically, even if the subject H1 (who is the creator of the first data D1) is the same, it may be appropriate to change the expression of the second data D2 depending on the receiver H2 of the second data D2. For example, if the receiver H2 of the second data D2 is a “kid,” then the sentence of the second data D2 is suitably a sentence adapted to “kids” such as a sentence using simple words.

Optionally, the automatic adjustment unit 15 may also adjust the conversion parameter according to the relationship between the subject H1 (who is the creator of the first data D1) and the second data D2 receiver H2, not just to the second data D2 receiver H2 alone. For example, if the second data D2 receiver H2 is a “boss” for the subject H1, then the second data D2 is suitably a sentence adapted to the “boss” such as a sentence that uses polite expressions. The automatic adjustment unit 15 adjusting the conversion parameter to an appropriate parameter allows the expression of the second data D2 to be modified adaptively to the second data D2 receiver H2.

Optionally, the automatic adjustment unit 15 may also adjust the conversion parameter according to emotion information representing the subject's H1 (who is the creator of the first data D1) current emotion estimated by the emotion estimation unit 23. For example, if the information about the subject's H1 emotion indicates that he or she is “sad,” then the second data D2 is suitably a sentence biased toward “sadness” to reflect the subject's H1 emotion.

Optionally, the automatic adjustment unit 15 may also adjust the conversion parameter according to emotion information representing the second data D2 receiver's H2 current emotion estimated by the emotion estimation unit 23. For example, if the information about the second data D2 receiver's H2 emotion indicates that he or she is “sad,” then the second data D2 is suitably a warm sentence that would console the receiver H2, for example.

Next, an emotion determination algorithm adopted by the emotion estimation unit 23 will be described with reference to FIG. 6. FIG. 6 illustrates an exemplary two-dimensional model, called “Russell's circumplex model,” representing a person's emotions.

Generally speaking, a person will feel various types of emotions such as delight and astonishment. In FIG. 6, various types of emotions felt by a person are plotted on a plane, of which the two axes respectively represent the arousal level indicating the degree of awakening and the valence level indicating the degree of pleasure. It is known that a person's emotions may be plotted in a circumplex pattern on such a plane.

The emotion estimation unit 23 calculates first, based on the subject's H1 data acquired by the input interface 2, for example, the arousal level indicating the degree of the subject's H1 awakening and the valence level indicating the degree of the subject's H1 pleasure.

For example, in calculating the arousal level based on the subject's H1 complexion, for example, the emotion estimation unit 23 compares the color red luminance value of an image representing the subject's H1 face with a reference color red luminance value of a normal complexion saved as a parameter. The arousal level calculated when the color red luminance value of the image representing the subject's H1 face is equal to the reference value is zero. As the color red luminance value of the image representing the subject's H1 face increases, the arousal level calculated increases as well.

For example, when calculating the valence level based on the subject's H1 facial expression, the emotion estimation unit 23 determines his or her expression based on the features of respective facial parts of the subject H1 image and calculates the valence level based on the correspondence between the expression and the valence level. The correspondence between the expression and the valence level is stored in a memory.

The emotion estimation unit 23 estimates the subject's H1 emotion based on the arousal level and valence level thus calculated. At this time, the emotion estimation unit 23 estimates the subject's H1 emotion based on the correspondence between the degree of a person's awakening or the degree of his or her pleasure and his or her emotion. The correspondence between the degree of a person's awakening or the degree of his or her pleasure and his or her emotion corresponds to the Russell's circumplex model shown in FIG. 6, for example, and stored in a memory. When using the Russell's circumplex model, the emotion estimation unit 23 plots, on a plane of which the ordinate represents the arousal level and the abscissa represents the valence level, a point corresponding to a combination of arousal and valence levels obtained, and estimates the emotion assigned to that point on the Russell's circumplex model to be the subject's H1 emotion.

For example, “neutral” is assigned to the center P0 of the Russell's circumplex model shown in FIG. 6 and a particular emotion is assigned by the two values of the arousal and valence levels. Specifically, in the example illustrated in FIG. 6, aroused, surprised, happy, relaxed, drowsy, boring, sad, irritated, angry, and fear emotions are assigned to the points P1, P2, P3, P4, P5, P6, P7, P8, P9, and P10, respectively.

Nevertheless, if a person's emotion is estimated only by his or her facial expression based on the Russell's circumplex model, for example, then the result of the estimation may match the actual emotion insufficiently. The reason is that non-physiological data such as data about a facial expression would be closely correlated to the valence level according to the Russell's circumplex model but would be hardly correlated to the arousal level. In addition, the arousal level according to the Russell's circumplex model would be highly correlated to physiological data such as the heart rate. Thus, the emotion would be estimated more accurately based on the Russell's circumplex model by using such non-physiological data and physiological data appropriately. That is to say, it is recommended that the emotion estimation unit 23 calculate, based on physiological data, the arousal level correlated relatively closely to the physiological data and calculate, based on non-physiological data, the valence level correlated relatively closely to the non-physiological data.

Physiological data is data about an organism's functions. Examples of the physiological data include data representing at least one of complexion, heart rate, variation in heart rate, low frequency/high frequency (LF/HF) of the heart rate, R-R interval, pulse wave, variation in pulsation, electroencephalogram, respiratory rate, respiratory volume, bloodstream, variation in bloodstream, blood pressure, variation in blood pressure, and oxygen saturation. The physiological data may also be data about movement of a body part, movement of a body muscle, movement of a facial muscle, body temperature, skin temperature, skin conductance, skin resistance, skin roughness, skin shine, amount of sweating, and sweat rate. Examples of the movement of a body part include the frequency and velocity of blinking.

Non-physiological data is data about an organism except the physiological data. Examples of non-physiological data include data representing at least one of expression, emotion, contact input signal, speech, language expressions, sentences, and gestures. In this case, data representing a facial expression may be data about the positions, shapes, and other parameters of the mouth, eyes, and eyebrows, which is readable from a face image. Data representing an emotion which is included in the non-physiological data may be obtained by a means other than the emotion estimation unit 23 and may be data entered by the subject H1 as his or her own emotion.

(3) Variations

Note that the first embodiment described above is only one of various embodiments of the present disclosure and should not be construed as limiting. Rather, the first embodiment may be readily modified in various manners depending on a design choice or any other factor without departing from the scope of the present disclosure. Also, the same functions as those of the data conversion system 10 may also be implemented as a data conversion method, a computer program, or a non-transitory storage medium that stores the computer program thereon.

A data conversion method according to an aspect includes: acquiring first data D1; and converting the first data D1 into second data D2 based on a conversion parameter to be determined by reference data related to a subject H1 and outputting the second data D2. A program according to another aspect is designed to cause a computer system to perform the data conversion method described above.

Variations of the first embodiment will be enumerated one after another. Note that the variations to be described below may be adopted in combination as appropriate.

The data conversion system 10 according to the present disclosure includes, as its major constituent element, a computer system, for example. The computer system includes a processor and a memory as its major hardware components. The computer system performs the function of the data conversion system 10 according to the present disclosure by making the processor execute a program stored in the memory. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a largescale integrated circuit (LSI). Those electronic circuits may be either integrated together on a single chip or distributed on multiple chips, whichever is appropriate. Those multiple chips may be integrated together in a single device or distributed in multiple devices without limitation.

Also, in the first embodiment described above, the plurality of functions of the data conversion system 10 are integrated together in a single housing. However, this is only an example and should not be construed as limiting. Alternatively, those constituent elements (or functions) of the data conversion system 10 may be distributed in multiple different housings. For example, the parameter storage unit 19 and the language conversion database 20 may be provided in two different housings. Still alternatively, at least some functions of the data conversion system 10 may be implemented as a server device and a cloud computing system as well. Conversely, at least some functions of the data conversion system 10 may be integrated together in a single housing.

In the first embodiment described above, first data D1 is supposed to be converted into second data D2 on a one-to-one basis. However, this is only an example and should not be construed as limiting. Alternatively, the data conversion system 10 may also convert a single item of first data D1 into two or more items of second data D2 (i.e., may perform one-to-multiple conversion). In that case, the data conversion system 10 outputs, as the result of conversion, two or more items of the second data D2 for a single item of the first data D1, and therefore, presents a plurality of conversion options. Still alternatively, the data conversion system 10 may also convert two or more items of first data D1 into a single item of second data D2 (i.e., may perform multiple-to-one conversion). Yet alternatively, the data conversion system 10 may further convert two or more items of first data D1 into two or more items of second data D2 (i.e., may perform multiple-to-multiple conversion).

Also, in the first embodiment described above, the data conversion system 10 is supposed to have a unidirectional conversion capability of converting first data D1 into second data D2. However, this is only an example and should not be construed as limiting. For example, the data conversion system 10 may also be configured to make bidirectional conversion from the first data D1 into the second data D2, and vice versa. That is to say, the data conversion system 10 may have two operation modes, namely, a forward conversion mode of converting the first data D1 into the second data D2 and a reverse conversion mode of converting the second data D2 into the first data D1. In that case, the data conversion system 10 is suitably configured to switch one of these two operation mode to the other.

Furthermore, in the first embodiment described above, the data conversion system 10 is supposed to selectively perform either the conversion parameter manual adjustment processing or the conversion parameter automatic adjustment processing depending on whether the operation mode is a manual mode or not. However, this is only an example and should not be construed as limiting. Alternatively, the data conversion system 10 may perform both the conversion parameter manual adjustment processing and the conversion parameter automatic adjustment processing. Still alternatively, the data conversion system 10 may perform neither the conversion parameter manual adjustment processing nor the conversion parameter automatic adjustment processing.

Furthermore, the subject does not have to be the creator of the first data D1, but may also be the receiver of the second data D2 or may even be a third party who is neither the creator of the first data D1 nor the receiver of the second data D2. For example, if the second data D2 is a sentence, then the reader or listener of the second data D2 is the receiver of the second data D2. If the receiver of the second data D2 is the subject, then the conversion unit 13 converts the first data D1 into the second data D2 based on the “conversion parameter” to be determined by reference data related to the subject who is the receiver of the second data D2. This allows the second data D2 generated by conversion to reflect the attributes of the subject who is the receiver of the second data D2. For example, if the second data D2 is a sentence, then this narrows the gap between the subject's usual style and the style of the second data D2 generated by conversion. Consequently, this data conversion system 10 also achieves the advantage of reducing the chances of the data conversion giving a sense of unnaturalness or uncomfortableness even when the subject is the receiver of the second data D2.

Furthermore, the first data D1 and the second data D2 do not have to be the same type of data (e.g., both are language data in the first embodiment described above) but may also be two different types of data. For example, when the first data D1 is painting (image) data, the second data D2 generated by conversion may be language data. Conversely, when the first data D1 is language data, the second data D2 generated by conversion may be painting (image) data.

Optionally, machine learning or any other artificial intelligence related technology is applicable to some type of processing to be performed by the data conversion system 10 such as the generation of the conversion parameter or the conversion to be performed by the conversion unit 13.

Furthermore, the subject does not have to be an existent person but may also be, for example, a famous writer who lived in the past. In that case, using text data extracted from a writer's X book as the reference data, for example, allows a conversion parameter corresponding to the writer X to be generated. By making conversion using this conversion parameter, the data conversion system 10 allows the first data D1 to be converted into second data D2 in the writer's X style, for example.

### Second Embodiment

In a data conversion system 10 according to a second embodiment, at least one of first data D1 or second data D2 is music data, which is a major difference from the data conversion system 10 according to the first embodiment described above. In the following description of the second embodiment, the first data D1 and the second data D2 are both supposed to be music (musical tune) data. In the following description, any constituent element of this second embodiment, having the same function as a counterpart of the first embodiment described above, will be designated by the same reference numeral as that counterpart's, and description thereof will be omitted herein as appropriate.

A data conversion system 10 according to this embodiment includes a music conversion database in place of the language conversion database 20 according to the first embodiment (see FIG. 1). The data conversion system 10 according to this embodiment converts first data D1 as an item of music data into second data D2 as another item of music data by using the music conversion data stored in the music conversion database. Specifically, the data conversion system 10 may perform, for example, processing such as an arrangement for converting first data D1 consisting of only a theme into second data D2 including sounds produced by various musical instruments added to the theme.

In this embodiment, the conversion unit 13 also converts the first data D1 into the second data D2 based on a “conversion parameter” to be determined by reference data related to the subject who is the creator (i.e., composer in this case) of the first data D1. This allows the second data D2 generated by conversion to reflect an expression peculiar to the subject who is the creator of the first data D1 (e.g., reflect a musical style peculiar to the subject who is the creator of the first data D1), thus narrowing the gap between the subject's usual musical style and the musical style of the second data D2 generated by conversion. As used herein, the “musical style” includes the key such as C major or C minor, chord progression, and rhythm of a musical tune composed, and musical instruments used to play the musical tune. Consequently, the data conversion system 10 according to this embodiment achieves the advantage of reducing the chances of the data conversion giving a sense of unnaturalness or uncomfortableness to the listener.

An exemplary arrangement will be described more specifically.

For example, first, the conversion unit 13 determines the key of the first data D1. For example, when finding theme included in the first data D1 to be a melody consisting mostly of Do, Re, Mi, and Sol notes, the conversion unit 13 determines the key of the first data D1 to be C major.

Thereafter, the conversion unit 13 estimates the chord progression of the first data D1 by breaking down the melody of the first data D1 on a measure-by-measure basis. For example, when finding the melody of the first measure consisting mostly of Do, Re, and Mi notes, the conversion unit 13 determines the chord matching the first measure to be the chord C (consisting of Do, Mi, and Sol notes). Next, when finding the melody of the second measure consisting mostly of Re, Mi, and Fa notes, the conversion unit 13 determines the chord matching the second measure to be the chord Dm (consisting of Re, Fa, and La notes). Furthermore, when finding the melody of the third measure consisting mostly of Sol, Si, La, and Re notes, the conversion unit 13 determines the chord matching the third measure to be the chord G7 (consisting of Sol, Si, Re, and Fa notes). Furthermore, when finding the melody of the fourth measure consisting mostly of Do, Re, and Mi notes, the conversion unit 13 determines the chord matching the fourth measure to be the chord C (consisting of Do, Mi, and Sol notes). Thus, the conversion unit 13 estimates the chord progression of the first data D1 to be a sequence “C-Dm-G7-C.” This is the simplest chord progression based on the melody of the original (i.e., the first data D1).

Next, the conversion unit 13 converts the chord progression of the first data D1 into the chord progression of the second data D2 based on a “conversion parameter” to be determined by reference data related to the subject who is the creator (composer) of the first data D1. At this time, in the case of a musical tune with a rock or pop music style, the conversion unit 13 converts the chord progression “C-Dm-G7-C” into a different chord progression “C-F-G7-C.” On the other hand, in the case of a musical tune with a jazz music style, the conversion unit 13 converts the chord progression “C-Dm-G7-C” into a different chord progression such as “C-Dm7-G7-C” or “Am-Dm-G7-C.” This allows a so-called “re-harmonization” process to be automatically performed by the data conversion system 10.

Optionally, after the re-harmonization process has been finished, the conversion unit 13 may modify the melody of the original musical tune (first data D1) such that the musical tune more closely matches the chord progression that has been changed. Suppose the chord of the first measure has been changed from C (consisting of Do, Mi, and Sol notes) into Am (consisting of La, Do, and Mi notes). In that case, the conversion unit 13 is allowed to modify the melody of the first measure from the one consisting mostly of Do, Re, and Mi notes on the chord C (consisting of Do, Mi, and Sol notes) into the one consisting mostly of La, Do, Re, and Mi notes on the chord Am (consisting of La, Do, and Mi notes).

Optionally, the configuration described for the second embodiment may be adopted as appropriate in combination with the configuration described for the first embodiment (including variations thereof).

(Resume)

As can be seen from the foregoing description, a data conversion system (10) according to a first aspect includes an acquisition unit (11), a conversion unit (13), and an output unit (12). The acquisition unit (11) acquires first data (D1). The conversion unit (13) converts the first data (D1) into second data (D2) based on a conversion parameter to be determined by reference data related to a subject. The output unit (12) outputs the second data (D2).

According to this aspect, the conversion unit (13) converts the first data (D1) into second data (D2) based on a conversion parameter to be determined by reference data related to a subject. This allows the second data (D2) generated by conversion to reflect an expression peculiar to the subject. For example, if the subject is the creator of the first data (D1), the second data (D2) generated by conversion is allowed to reflect the expression peculiar to the creator of the first data (D1), thus narrowing the gap between the subject's usual expression and the expression of the second data (D2) generated by conversion. Consequently, this data conversion system (10) achieves the advantage of reducing the chances of the data conversion giving a sense of unnaturalness or uncomfortableness to the user.

A data conversion system (10) according to a second aspect, which may be implemented in conjunction with the first aspect, further includes a parameter output unit (14) to output the conversion parameter.

This aspect allows the conversion parameter to be visualized or used in another system.

In a data conversion system (10) according to a third aspect, which may be implemented in conjunction with the first or second aspect, at least one of the first data (D1) or the second data (D2) is language data.

This allows the second data (D2) generated by conversion to reflect the subject's style or any other attribute of his or hers, thus narrowing the gap between the subject's usual style or any other attribute of his or hers and the style or any other property of the second data (D2) generated by conversion.

In a data conversion system (10) according to a fourth aspect, which may be implemented in conjunction with the third aspect, the first data (D1) and the second data (D2) are language data of the same classification.

This aspect allows the second data (D2) generated by conversion to reflect the subject's style or any other attribute of his or hers without changing the classification of the language (e.g., from Japanese into Japanese).

In a data conversion system (10) according to a fifth aspect, which may be implemented in conjunction with the third aspect, the first data (D1) and the second data (D2) are language data of mutually different classifications.

This aspect allows the second data (D2) generated by conversion to reflect the subject's style or any other attribute of his or hers while changing the classification of the language (e.g., from Japanese into English).

In a data conversion system (10) according to a sixth aspect, which may be implemented in conjunction with the first or second aspect, at least one of the first data (D1) or the second data (D2) is music data.

This aspect allows the second data (D2) generated by conversion to reflect the subject's musical style or any other attribute of his or hers, thus narrowing the gap between the subject's usual musical style or any other attribute of his or hers and the musical style or any other property of the second data (D2) generated by conversion.

A data conversion system (10) according to a seventh aspect, which may be implemented in conjunction with any one of the first to sixth aspects, further includes an operating unit (16) and an adjustment unit (17). The operating unit (16) receives an operating signal representing an operating command entered by a person. The adjustment unit (17) adjusts the conversion parameter in accordance with the operating signal.

This aspect allows the conversion parameter to be adjusted manually, thus making the conversion parameter adjustable according to the mood or preference of the receiver of the second data (D2), for example.

In a data conversion system (10) according to an eighth aspect, which may be implemented in conjunction with the seventh aspect, the operating unit (16) receives the operating signal generated by an operation of moving a position of a cursor (302) on a parameter gauge (301) displayed on a display unit (31). The parameter gauge (301) represents the conversion parameter by a cursor (302) position.

This aspect allows the user to adjust the conversion parameter intuitively, thus facilitating the adjustment of the conversion parameter.

A data conversion system (10) according to a ninth aspect, which may be implemented in conjunction with any one of the first to eighth aspects, further includes an automatic adjustment unit (15) to automatically adjust the conversion parameter.

This aspect lightens the user's operating load by saving him or her the trouble of manual adjustment.

In a data conversion system (10) according to a tenth aspect, which may be implemented in conjunction with the ninth aspect, the automatic adjustment unit (15) adjusts the conversion parameter according to emotion information representing a person's emotions.

This aspect allows the first data (D1) to be converted into appropriate second data (D2) adapted to the subject's emotion, for example.

In a data conversion system (10) according to an eleventh aspect, which may be implemented in conjunction with any one of the first to tenth aspects, the conversion parameter includes multiple items.

This aspect allows the conversion parameter to be set in further detail compared to a situation where the conversion parameter consists of a single item, thus enabling the second data (D2) generated by conversion to reflect the subject's unique expression more easily.

In a data conversion system (10) according to a twelfth aspect, which may be implemented in conjunction with the eleventh aspect, the conversion unit (13) converts the first data (D1) into the second data (D2) by collectively using all of the multiple items of the conversion parameter at a time.

This aspect reduces the chances of causing an error of generating no second data (D2), i.e., bringing about no solution with respect to the second data (D2).

In a data conversion system (10) according to a thirteenth aspect, which may be implemented in conjunction with the eleventh aspect, the conversion unit (13) converts the first data (D1) into the second data (D2) by sequentially using one of the multiple items of the conversion parameter after another.

This aspect has the options of the second data (D2) narrowed down step by step, thus allowing the second data (D2) generated by conversion to reflect the subject's peculiar expressions relatively finely.

A data conversion system (10) according to a fourteenth aspect, which may be implemented in conjunction with any one of the first to thirteenth aspects, further includes a selection unit (18). The selection unit (18) selects the conversion parameter for use in conversion by the conversion unit (13) from a plurality of potential parameters associated one to one with a plurality of potential subjects. The subject is determined to be one of the plurality of potential subjects.

This aspect allows the second data (D2) generated by conversion to reflect respective expressions unique to the plurality of potential subjects.

In a data conversion system (10) according to a fifteenth aspect, which may be implemented in conjunction with any one of the first to fourteenth aspects, the conversion unit (13) performs first conversion processing and second conversion processing. The first conversion processing is the processing of converting the first data (D1) into standard data that has been standardized. The second conversion processing is the processing of converting the standard data into the second data (D2) based on the conversion parameter.

This aspect has the first data (D1) standardized once, thus making the conversion parameter usable in common irrespective of the first data (D1).

A data conversion method according to a sixteenth aspect includes: acquiring first data (D1); and converting the first data (D1) into second data (D2) based on a conversion parameter to be determined by reference data related to a subject and outputting the second data (D2).

According to this aspect, the first data (D1) is converted into second data (D2) based on a conversion parameter to be determined by reference data related to a subject. This allows the second data (D2) generated by conversion to reflect an expression peculiar to the subject. For example, if the subject is the creator of the first data (D1), the second data (D2) generated by conversion is allowed to reflect the expression peculiar to the creator of the first data (D1), thus narrowing the gap between the subject's usual expression and the expression of the second data (D2) generated by conversion. Consequently, this data conversion method achieves the advantage of reducing the chances of the data conversion giving a sense of unnaturalness or uncomfortableness to the user.

A program according to a seventeenth aspect is designed to cause a computer system to perform the data conversion method according to the sixteenth aspect.

According to this aspect, the first data (D1) is converted into second data (D2) based on a conversion parameter to be determined by reference data related to a subject. This allows the second data (D2) generated by conversion to reflect an expression peculiar to the subject. For example, if the subject is the creator of the first data (D1), the second data (D2) generated by conversion is allowed to reflect the expression peculiar to the creator of the first data (D1), thus narrowing the gap between the subject's usual expression and the expression of the second data (D2) generated by conversion. Consequently, this program achieves the advantage of reducing the chances of the data conversion giving a sense of unnaturalness or uncomfortableness to the user.

Note that these are only exemplary aspects of the present disclosure. Rather, various aspects (including variations) of the data conversion system (10) according to the first and second embodiments described above are also implementable as a data conversion method and a program.

Also, the constituent elements according to the second to fifteenth aspects are not essential constituent elements for the data conversion system (10) but may be omitted as appropriate.

### REFERENCE SIGNS LIST

10 Data Conversion System
11 Acquisition Unit
12 Output Unit
13 Conversion Unit
14 Parameter Output Unit
15 Automatic Adjustment Unit
16 Operating Unit
17 Adjustment Unit
18 Selection Unit
31 Display Unit
301 Parameter Gauge
302 Cursor
D1 First Data
D2 Second Data
H1 Subject

1. A data conversion system comprising:
an acquisition unit configured to acquire first data;
a conversion unit configured to convert the first data into second data based on a conversion parameter to be determined by reference data related to a subject; and
an output unit configured to output the second data.

2. The data conversion system of claim 1, further comprising a parameter output unit configured to output the conversion parameter.

3. The data conversion system of claim 1, wherein
at least one of the first data or the second data is language data.

4. The data conversion system of claim 3, wherein
the first data and the second data are language data of the same classification.

5. The data conversion system of claim 3, wherein
the first data and the second data are language data of mutually different classifications.

6. The data conversion system of claim 1, wherein
at least one of the first data or the second data is music data.

7. The data conversion system of claim 1, further comprising
an operating unit configured to receive an operating signal representing an operating command entered by a person; and
an adjustment unit configured to adjust the conversion parameter in accordance with the operating signal.

8. The data conversion system of claim 7, wherein
the operating unit is configured to receive the operating signal generated by an operation of moving a position of a cursor on a parameter gauge representing, by a cursor position, the conversion parameter displayed on a display unit.

9. The data conversion system of claim 1, further comprising an automatic adjustment unit configured to automatically adjust the conversion parameter.

10. The data conversion system of claim 9, wherein
the automatic adjustment unit is configured to adjust the conversion parameter according to emotion information representing a person's emotions.

11. The data conversion system of claim 1, wherein
the conversion parameter includes multiple items.

12. The data conversion system of claim 11, wherein
the conversion unit is configured to convert the first data into the second data by collectively using all of the multiple items of the conversion parameter at a time.

13. The data conversion system of claim 11, wherein
the conversion unit is configured to convert the first data into the second data by sequentially using one of the multiple items of the conversion parameter after another.

14. The data conversion system of claim 1, further comprising a selection unit configured to select the conversion parameter for use in conversion by the conversion unit from a plurality of potential parameters associated one to one with a plurality of potential subjects, the subject being determined to be any one of the plurality of potential subjects.

15. The data conversion system of claim 1, wherein
the conversion unit is configured to perform:
first conversion processing of converting the first data into standard data that has been standardized; and
second conversion processing of converting the standard data into the second data based on the conversion parameter.

16. A data conversion method comprising
acquiring first data; and
converting the first data into second data based on a conversion parameter to be determined by reference data related to a subject and outputting the second data.

17. A program designed to cause a computer system to perform the data conversion method of claim 16.
